(19) United States
(12) Patent Application Publication
(10) Pub. No.: US 2008/0303949 A1
(43) Pub. Date: Dec. 11, 2008

(54) MANIPULATING VIDEO STREAMS

(75) Inventors: Jean Pierre Ciudad, San Francisco, CA (US); Michael Stochosky, San Francisco, CA (US); Chendi Zhang, Mountain View, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/760,723

(22) Filed: Jun. 8, 2007

(51) Int. Cl. H04N 9/74

(52) U.S. Cl. 348/586; 348/E09.055

(57) ABSTRACT

Methods, systems and apparatus, including computer program products, for manipulating video streams in videoconference session. A reference background image is identified from a first video frame in a video stream of a videoconferencing environment. A subsequent video frame from the video stream is received. Areas of the subsequent video frame corresponding to a foreground area are identified. The foreground area includes pixels of the subsequent video frame that are different from corresponding pixels in the first video frame. The foreground area is transformed based on a selected image transformation. The transformed foreground area is composited onto the reference background image into a composite video frame.

### TECHNICAL FIELD

This document relates to videoconferencing.

### BACKGROUND

Videoconferencing systems allow a user to transmit a video stream to participants of a videoconference session. Typically, the content of the video stream depicts the user of the videoconferencing system, as captured by a video capture device such as a web cam. Some videoconferencing systems allow a user to selectively apply video transformation filters that affect the video stream. Typically these transformations affect entire frames in the video stream. For example, a transformation can be used to decolorize the video stream so that the video stream depicts black and white video. Other videoconferencing systems allow a user to selectively replace or transform background areas of video frames in the video stream. Background areas of the video stream are areas of the video frame that do not change (or have not changed) from one frame to the next.

### SUMMARY

In general, one aspect of the subject matter described in this specification can be embodied in methods that include the actions of identifying a reference background image from a first video frame in a video stream of a videoconferencing environment. A subsequent video frame from the video stream is received. Areas of the subsequent video frame corresponding to a foreground area are identified. The foreground area includes pixels of the subsequent video frame that are different from corresponding pixels in the first video frame. The foreground area is transformed based on a selected image transformation. The transformed foreground area is composited onto the reference background image into a composite video frame. Other embodiments of this aspect include corresponding systems, apparatus, and computer program products.

These and other embodiments can optionally include one or more of the following features. The composite video frame can be sent to participants in the videoconferencing environment. The video stream can be captured by an attached video capture device. The selected image transformation can include one or more of panning, inverting, rotating, blurring, pixelating, resizing, decolorizing and color-adjusting. Compositing the foreground area can include using a transparency value associated with the foreground area. The reference background image can be transformed based on another selected image transformation. The foreground area can be composited against an alternative background image. The alternative background image can be selected from one of multiple alternative background images. Determining that the first video frame from the video stream corresponds to a reference background image can include detecting an absence of motion in the first video frame compared to a plurality of previously received video frames. The absence of motion can be detected when the pixels of the video frame and the plurality of previously received video frames are substantially the same. A user interface can be provided for determining a reference background image from the video stream. The user interface can indicate that the reference background image is being determined. User input can be received identifying a point in time for determining the reference background image from the video stream. An indication can be provided in the user interface when an amount of motion detected in the video stream is above a threshold.

Particular embodiments of the subject matter described in this specification can be implemented to realize one or more of the following advantages. The foreground area of a video stream can be manipulated and transformed without affecting the background. In a videoconferencing environment, the depiction of a videoconference participant, being in the foreground, can be visually affected to such an extent that parts of the background can be made visible that would otherwise be occluded by the participant.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a screenshot showing a videoconference.

FIG. 2 is a flow chart for an example method used to capture a background image.

FIGS. 3A-3C are screenshots of presentations displayed during a background capture

FIG. 4 is a screenshot showing a presentation of a video frame modified by an image transformation.

FIG. 5 is a flow chart for an example method used to generate a transformed video stream.

FIG. 6 is a block diagram of an example computing system that can be used in connection with computer-implemented methods described in this document.

Like reference symbols in the various drawings indicate like elements.

### DETAILED DESCRIPTION

The systems, apparatus, methods and techniques described in this document relate generally to applying image transformations in a captured video stream. One such image transformation can include resizing a foreground area of a captured video stream. The video stream can be captured by a webcam, digital video recorder or other video capture device. Such video capture devices can be attached to a computing or processing device in a variety of ways. For example, a camera can be mounted in a computer monitor frame, such as a built-in iSight camera available from Apple Inc. of Cupertino, Calif. The video capture device can be coupled with a computing device through a wireline connection, such as a universal serial bus (USB) connection, a firewire connection, or the video capture device can be coupled through a wireless connection, to name a few examples. The computing device to which the video capture device is coupled can include a laptop computer, a desktop computer, a phone, or other electronic or processing devices, to name a few examples.

In some implementations, the systems, apparatus, methods and techniques can be used in a videoconference environment. In general, the videoconference environment allows one or more participants to communicate, typically by exchanging an audio stream, a video stream or both. For example, consider participants A, B and C. Participant A can send a video stream captured by their respective video capture device to participants B and C. Moreover, participant A can receive a video stream sent from participants B and/or C captured by their respective video capture devices. Typically, the captured video stream is a sequence of video frames. In general, a predetermined number of frames are captured over a set time interval. For example, a video capture device can capture thirty frames per second, sixty frames per second, or some other number of frames over an interval (e.g., a one-second interval). In some implementations, the number of frames captured per second by the video capture device can be modified over the course of a videoconference session. For example, a videoconference participant can reduce the number of captured frames per second to reduce the amount of video data exchanged with other participants. In some implementations, the video stream can also be sent with captured audio that can be heard by the other participants of the videoconference. For example, the video capture device can capture the audio, or another audio capture device, such as a microphone, can capture the audio. The captured audio can be sent with the captured video stream to one or more videoconference participants over a network, such as a local area network (LAN), a wide area network (WAN), or the Internet to name a few examples.

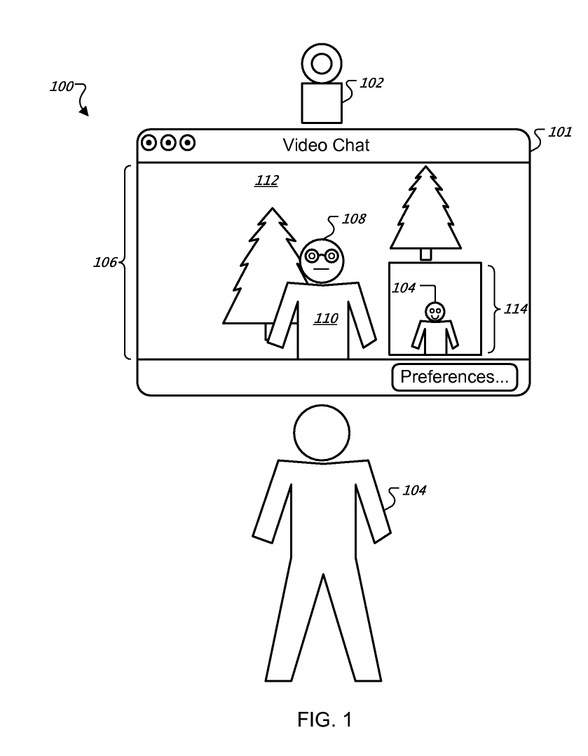

Referring to FIG. 1, a videoconference 100 is shown. In general, the videoconference 100 can be facilitated by a videoconference application 101. In general, a user of the videoconference application 101 can start a videoconference session by calling another user or can join an existing videoconference session as a participant of the session. Typically, after the user starts or joins a videoconference they can participate in the videoconference by sending and receiving video and/or audio. The videoconference application 101 can communicate with a video capture device coupled with a computing device. For example, the videoconference application 101 can receive a video stream from video capture device 102. The captured video stream can include one or more video frames.

The video frames can be analyzed to identify a reference background image. The reference background image is subsequently used to identify foreground areas of the video stream. Subsequently, the identified foreground area can be transformed in the video stream provided to other participants of the videoconference session.

The videoconference application 101 includes a viewing area 106. For example, the viewing area 106 is used to present a video stream of another participant 108 that is captured by a video capture device coupled with the other participant's 108 computing device. Typically, the foreground area 110 of a video stream corresponds to the part of the video stream that depicts a videoconference participant, while the background area 112 corresponds to all other depicted areas. The videoconference application 101 can be used to identify a reference background image. Once identified, the reference background image is an static image that is presumed to depict the background—any areas of subsequent video frames that differ from the reference background image are determined to be foreground areas. Typically the reference background depicts whatever is in the field of view of the video capture image without the participant or other item of interest occluding any part of that field of view. To identify the reference background image, the videoconference application 101 can prompt a participant to move out of view of the video capture device 102. Once the videoconference application 101 determines that the participant is out of view, the application 101 can capture video frames from which a reference background image can be derived.

Subsequently, the videoconference application 101 can apply one or more image transformations to the video stream. In particular, the foreground areas of the video stream can be manipulated independently of the background areas. For example, the videoconference application 101 can apply a panning, inverting, rotating, blurring, pixelating, resizing, decolorizing, or color-adjusting image transformation to a foreground area 110 of the captured video frame. So as to facilitate transformations of the foreground area that would reveal areas in the field of view that are occluded by the participant, the foreground area 110 of each video frame is composited with the reference background image to generate the desired effect. In such implementations, the composite video stream is sent to the other videoconference participants.

The videoconference application 101 can also include a preview area 114. The preview area 114 can show a user of the videoconference application 101 a substantially similar copy of one or more video frames that are sent to other participants of the videoconference. For example, participant 104 can view a copy of the video frames that are sent to participant 108 in preview area 114. In addition, the preview area 114 can show a participant the captured video frames after being altered by one or more image transformations. For example, the preview area 114 can show participant 104 captured video frames after a blurring image transformation is applied to the foreground area 110.

In some implementations, the preview area 114 can be subdivided showing one or more different examples of captured video frames corresponding to the application of different image transformations to the captured video frames. For example, the preview area 114 can be divided into a normal view (e.g., no image transformations are applied to the captured video frames), an inverted view (e.g., where the foreground area has been inverted relative to the background), a magnified view (e.g., where the foreground area has been enlarged) and other views corresponding to one or more image transformations. Moreover, in some such implementations, a participant can select an image transformation from the preview area 114 and apply it to the capture video stream in real-time. For example, participant 104 can select to invert the foreground area of the video stream during the videoconference and all other participants (e.g., participant 108) will receive a video stream wherein the foreground area of the video stream (e.g., depicting the participant 104) are inverted.

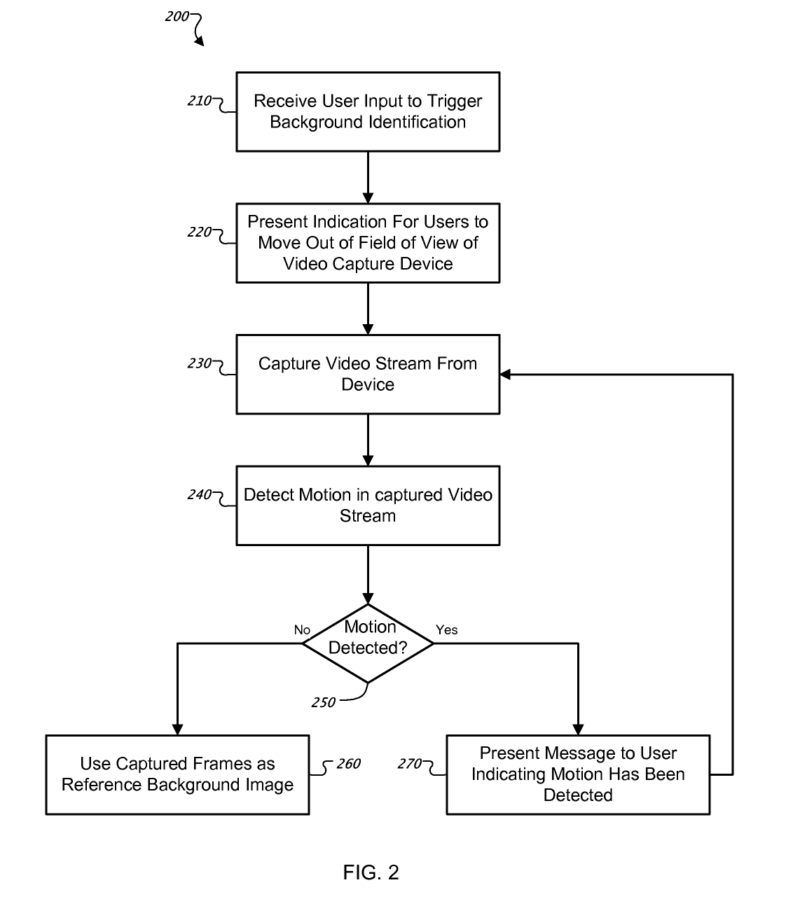

FIG. 2 is a flow chart for an example method 200 used to capture a reference background image. In general, a videoconference participant informs the videoconference application 101 that the application should capture a reference background image. The videoconference application 101 can then capture one or more images and determine an absence of motion. If an absence of motion is detected, the video conferencing application 101 can store video frame data as the reference background image. Otherwise, an error message can be displayed. Some or all of method 200 can be repeated as necessary to generate an appropriate reference background image. In some implementations, a user of the videoconference environment can capture a reference background image without participating in a videoconference. In other words, a videoconference need not be in progress to execute any portion of method 200.

In step 210, user input is received to invoke reference background image identification. For example, a user can press a button on a user interface of the videoconference application 101 to initiate a background capture. As another example, the user can select a menu item from a pull-down menu, press a key on a keyboard, or use another type of input device to initiate a background capture. In general, invoking reference background identification indicates that the system can begin to detect a reference background from the video stream being captured.

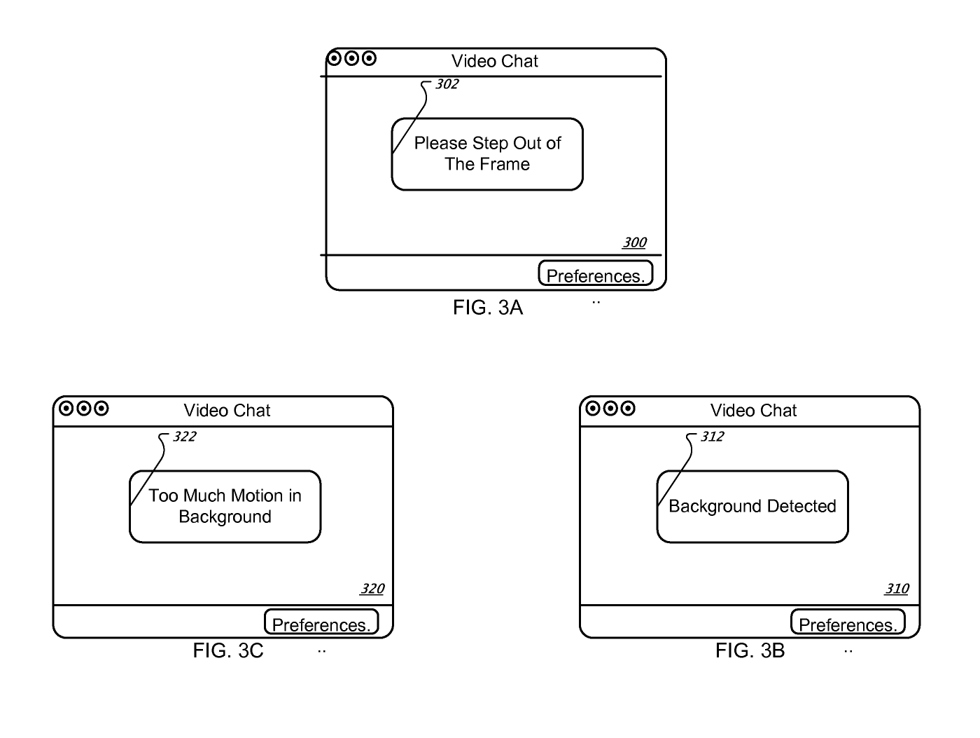

In step 220, an indication to move out of the field of view of the video capture device is presented to the user. For example, FIG. 3A shows a screenshot of a presentation 300 indicating that background image capture is about to begin. As illustrated by the presentation 300, a message 302 is displayed instructing the user to move out of view of the video capture device so that a reference background image can be identified. In some implementations, the message 302 is generated using a different transparency value so that the videoconference is not obscured by the warning, for example.

Returning to FIG. 2, in step 230 the system captures a video stream from a video capture device. The videoconference application 101 uses one or more video frames from the video stream to determine an amount of motion in the captured video frames.

In step 240, motion in the captured video stream is detected. For example, pixels in substantially similar positions among different frames of the video stream can be compared to determine a difference in color values. In some implementations, the differences of all pixels are summed to determine whether frames of the video stream are substantially the same (e.g., the same color). If the sum of differences is greater than some specified threshold then the system can determine that motion is occurring. If the sum of differences is less than the threshold, then the system determines that no motion is detected. In other implementations, a gradient can be calculated to measure a magnitude and direction of the change across video frames for one or more pixels and their corresponding pixel values. The gradient can be used to detect motion in step 250. In some implementations, the video stream is analyzed on a frame-by-frame basis. For example, one or more captured frames can be compared to other frames to detect motion.

In step 260, if motion is not detected, the videoconference application 101 can use the captured frames as the reference background image. For example, FIG. 3B shows a screenshot of a presentation 310 indicating that a reference background image has been detected. As illustrated by the presentation 310, a message 312 is displayed indicating that a background has successfully been detected.

Returning to FIG. 2, in step 270, in some implementations, if motion is detected, the videoconference application 101 presents a message to the participant indicating that movement has been detected. For example, FIG. 3C, shows a screenshot of a presentation 320 indicating motion above a threshold is detected. In the illustrated example, the videoconference application 101 can display message 322 indicating that too much motion was detected. As another example, the one or more pixels where motion was detected can be highlighted by modifying the pixel value, such as adding red to the color of the identified pixels. The videoconference application continues to determine whether motion is being detected (e.g., return to step 230), until motion has not been detected or user input is received interrupting acquisition of the reference background image.

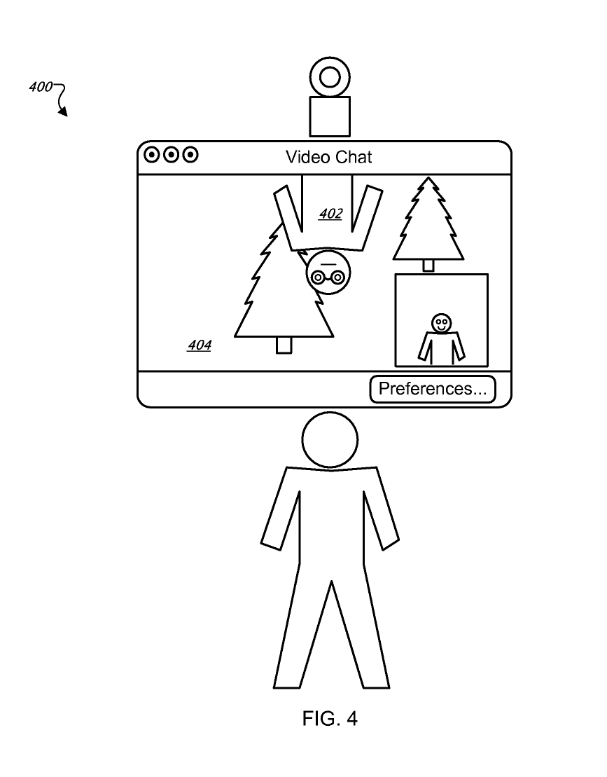

FIG. 4 is a screenshot showing a presentation 400 of a video frame modified by an image transformation. One or more image transformations can be applied to the foreground area of the video stream. For example, the presentation 400 shows an application of an image transformation that inverts the foreground area 402 of the video frame. The foreground area 402 can be composited with reference background image 404 to form a composite video stream that is sent to one or more videoconference participants. In some implementations, the foreground area 402 can be identified by comparing pixels of a video frame with corresponding pixels in the reference background image. For example, one or more pixel values can be measured, and a gradient determined measuring a magnitude of change of the one or more pixel values compared to the reference background image. Pixels with a gradient value greater than a predetermined threshold can be considered in the foreground area 402. Pixels with a gradient value less than or equal to a predetermined threshold can be considered background data 404.

The foreground area 402 can be transformed according to the selected image transformation and composited with the reference background image 404 without additional user intervention.

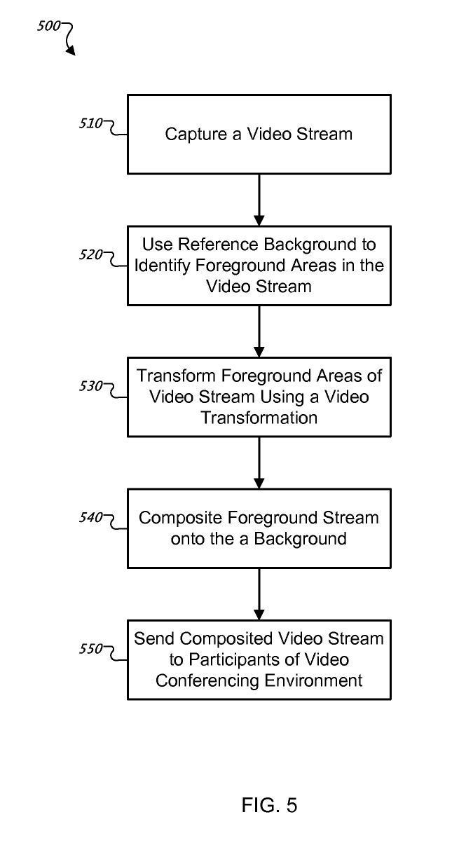

FIG. 5 is a flow chart for an example method 500 used to generate a transformed video stream. In general, a video stream is captured and a reference background image is used to identify a foreground area. The foreground area can be transformed using various image transformations and composited with the reference background image to generate a composite video stream. The composite video stream can then be transmitted to one or more participants of a videoconference. The method 500 can be repeated any number of times to generate an uninterrupted transformed video stream.

In step 510, a video stream is captured. For example, a webcam can capture a video stream corresponding to the actions of a videoconference participant. In some implementations, the video stream can also include audio. For example, the video stream can include audio corresponding to sounds uttered by the videoconference participant.

In step 520, a reference background image is used to identify foreground areas in the video stream. For example, each pixel in the captured video stream can be compared with each pixel in the reference background image. For each pixel with a substantially similar pixel value, that pixel can be identified as a pixel a part of the background area of the video stream. Pixels with substantially different pixel values can be identified as foreground areas of the video stream.

In step 530, foreground areas of the video stream are transformed using a video transformation. For example, applying one or more video transformations can modify the pixel values or modify the position of the pixels in the foreground area. Video transformations include, but are not limit to, panning, inverting, rotating, blurring, pixelating, resizing, decolorizing and color-adjusting, to name a few examples. In some implementations, multiple transformations can be applied to an area of a video frame in combination. For example, both a blurring and inverting image transformation can be applied to the foreground area 110.

In step 540, a portion of each video frame in the video stream that corresponds to the transformed foreground area is composited onto the reference background image. In some implementations, a transparency value of the foreground area can be modified during the composition. For example, the transparency value of the foreground area can be modified so that the foreground area appears to be semi-transparent.

In some implementations, instead of compositing the transformed foreground area onto the reference background image, the transformed foreground area can be composited over an alternative background image. For example, the participant can select an outdoor scene, a cityscape, an image of Time Square, another video stream, or other background images that the user has captured. Alternatively, the background image used in the composition can be a transformed version of the reference background image. Thus, the background area of the video stream can be separately modified by image transformations. In some implementations, the method 200 can be repeated any number of times to capture any number of alternative background images. For example, a reference background image can be stored as alternative background image. Multiple alternative background images can be presented (e.g., in the preview area 114) so that a user may select one of the images to use as the background image in the composition.

In some implementations, when a background image has been identified, the background image can be transmitted to once to all participants of a video conference session. Subsequently, only portions of the foreground area of the video stream are transmitted to video conference participants. These foreground area updates are composited with background image separately for each participant. Such an implementation, can advantageously save transmission bandwidth by transmitting at most only the foreground area of the video stream.

In step 550, the composited video stream is sent to the participants of the video conferencing environment. This allows the other participants of the videoconference to view the composited video stream. For example, the other participants can view an inverted representation of a participant who has selected to invert the foreground area of their video stream. Moreover, participants can view changes to the video streams in real-time. For example, participant A can view when participant B modifies their selected transformation, their background image, their background image transformation, or combinations thereof.

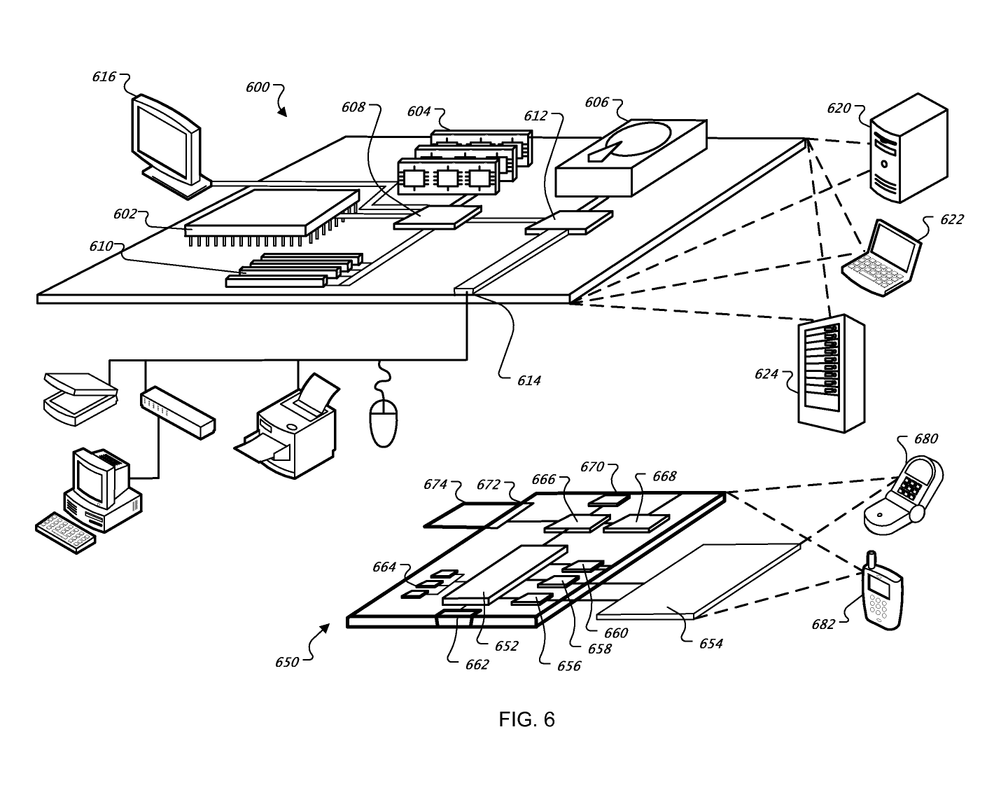

FIG. 6 is a block diagram of computing devices 600, 650 that can be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses can be used, as appropriate, along with multiple memories and types of memory. Also, multiple computing devices 600 can be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 can be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, memory on processor 602, or a propagated signal.

The high-speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which can accept various expansion cards (not shown). In the implementation, low-speed controller 612 is coupled to storage device 606 and low-speed expansion port 614. The low-speed expansion port, which can include various communication ports (e.g., USB, Bluetooth, Ethernet, wireless Ethernet), can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. It can also be implemented as part of a rack server system 624. In addition, it can be implemented in a personal computer such as a laptop computer 622. Alternatively, components from computing device 600 can be combined with other components in a mobile device (not shown), such as device 650. Each of such devices can contain one or more of computing device 600, 650, and an entire system can be made up of multiple computing devices 600, 650 communicating with each other.

Computing device 650 includes a processor 652, memory 664, an input/output device such as a display 654, a communication interface 666, and a transceiver 668, among other components. The device 650 can also be provided with a storage device, such as a microdrive or other device, to provide additional storage. Each of the components 650, 652, 664, 654, 666, and 668, are interconnected using various buses, and several of the components can be mounted on a common motherboard or in other manners as appropriate.

The processor 652 can process instructions for execution within the computing device 650, including instructions stored in the memory 664. The processor can also include separate analog and digital processors. The processor can provide, for example, for coordination of the other components of the device 650, such as control of user interfaces, applications run by device 650, and wireless communication by device 650.

Processor 652 can communicate with a user through control interface 658 and display interface 656 coupled to a display 654. The display 654 can be, for example, a TFT LCD display or an OLED display, or other appropriate display technology. The display interface 656 can comprise appropriate circuitry for driving the display 654 to present graphical and other information to a user. The control interface 658 can receive commands from a user and convert them for submission to the processor 652. In addition, an external interface 662 can be provided in communication with processor 652, so as to enable near area communication of device 650 with other devices. External interface 662 can provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 can also be provided and connected to device 650 through expansion interface 672, which can include, for example, a SIMM card interface. Such expansion memory 674 can provide extra storage space for device 650, or can also store applications or other information for device 650. Specifically, expansion memory 674 can include instructions to carry out or supplement the processes described above, and can include secure information also. Thus, for example, expansion memory 674 can be provided as a security module for device 650, and can be programmed with instructions that permit secure use of device 650.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal.

Device 650 can communicate wirelessly through communication interface 666, which can include digital signal processing circuitry where necessary. Communication interface 666 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 668. In addition, short-range communication can occur, such as using a Bluetooth, WiFi, or other such transceiver (not shown). In addition, GPS receiver module 670 can provide additional wireless data to device 650, which can be used as appropriate by applications running on device 650.

Device 650 can also communicate audibly using audio codec 660, which can receive spoken information from a user and convert it to usable digital information. Audio codec 660 can likewise generate audible sound for a user, such as through a speaker, e.g., in a handset of device 650. Such sound can include sound from voice telephone calls, can include recorded sound (e.g., voice messages, music files, etc.) and can also include sound generated by applications operating on device 650.

The computing device 650 can be implemented in a number of different forms, as shown in the figure. For example, it can be implemented as a cellular telephone 660. It can also be implemented as part of a smartphone 662, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other categories of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Embodiments can be implemented, at least in part, in hardware or software or in any combination thereof. Hardware can include, for example, analog, digital or mixed-signal circuitry, including discrete components, integrated circuits (ICs), or application-specific ICs (ASICs). Embodiments can also be implemented, in whole or in part, in software or firmware, which can cooperate with hardware. Processors for executing instructions can retrieve instructions from a data storage medium, such as EPROM, EEPROM, NVRAM, ROM, RAM, a CD-ROM, a HDD, and the like. Computer program products can include storage media that contain program instructions for implementing embodiments described herein.

A number of embodiments of the invention have been described. Nevertheless, it will be understood that various modifications may be made without departing from the spirit and scope of the invention. Accordingly, other embodiments are within the scope of the following claims.

What is claimed is:

1. A method comprising:
identifying a reference background image from a first video frame in a video stream of a videoconferencing environment;
receiving a subsequent video frame from the video stream;
identifying areas of the subsequent video frame corresponding to a foreground area, the foreground area including pixels of the subsequent video frame that are different from corresponding pixels in the first video frame;
transforming the foreground area based on a selected image transformation; and
compositing the transformed foreground area onto the reference background image into a composite video frame.

2. The method of claim 1, further comprising:
sending the composite video frame to participants in the videoconferencing environment.

3. The method of claim 1, wherein the video stream is being captured by an attached video capture device.

4. The method of claim 1, wherein the selected image transformation includes one or more of panning, inverting, rotating, blurring, pixelating, resizing, decolorizing and color-adjusting.

5. The method of claim 1, wherein compositing the foreground area includes using a transparency value associated with the foreground area.

6. The method of claim 1, further comprising:
transforming the reference background image based on another selected image transformation.

7. The method of claim 1, further comprising:
compositing the foreground area against an alternative background image, the alternative background image being selected from one of multiple alternative background images.

8. The method of claim 1, where determining that the first video frame from the video stream corresponds to a reference background image, includes:
detecting an absence of motion in the first video frame compared to a plurality of previously received video frames, the absence of motion being detected when the pixels of the video frame and the plurality of previously received video frames are substantially the same.

9. The method of claim 1, further comprising:
providing a user interface for determining a reference background image from the video stream; and
indicating in the user interface that the reference background image is being determined.

10. The method of claim 9, further comprising:
receiving user input identifying a point in time for determining the reference background image from the video stream.

11. The method of claim 9, further comprising:
providing an indication in the user interface when an amount of motion detected in the video stream is above a threshold.

12. A computer program product, encoded on a computer-readable medium, operable to cause data processing apparatus to:
identify a reference background image from a first video frame in a video stream of a videoconferencing environment;
receive a subsequent video frame from the video stream;
identify areas of the subsequent video frame corresponding to a foreground area, the foreground area including pixels of the subsequent video frame that are different from corresponding pixels in the first video frame;
transform the foreground area based on a selected image transformation; and
composite the transformed foreground area onto the reference background image into a composite video frame.

13. A system comprising:
means for identifying a reference background image from a first video frame in a video stream of a videoconferencing environment;
means for receiving a subsequent video frame from the video stream;
means for identifying areas of the subsequent video frame corresponding to a foreground area, the foreground area including pixels of the subsequent video frame that are different from corresponding pixels in the first video frame;
means for transforming the foreground area based on a selected image transformation; and
means for compositing the transformed foreground area onto the reference background image into a composite video frame.
